(19) United States
(12) Patent Application Publication
(10) Pub. No.: US 2025/0092718 A1
(43) Pub. Date: Mar. 20, 2025

(54) LOCK AND HASP

(71) Applicant: Illinois Tool Works Inc., Glenview, IL (US)

(72) Inventors: Garry STEVENS, London (GB); Lorraine Noyem MORDI, London (GB); Nicky SLATER, London (GB)

(73) Assignee: Illinois Tool Works Inc., Glenview, IL (US)

(21) Appl. No.: 18/882,374

(22) Filed: Sep. 11, 2024

(30) Foreign Application Priority Data
Sep. 15, 2023 (GB) 2314110.4

(51) Int. Cl. E05B 65/48; E05B 39/02

(52) U.S. Cl. CPC E05B 65/48; E05B 39/02

(57) ABSTRACT

A lock, suitable for locking an airline cart, the lock comprising, a body, at least two locking arms housed within the body, and a biasing means, the biasing means arranged to urge a first locking arm and a second locking towards a maximum limit. The at least two locking arms are configured to resist removal of a hasp inserted into the lock. The at least two locking arms are tied to one another such that the at least two locking arms may reversibly move relative to one another, and an amount of movement of a first locking arm relative to a second locking arm is up to the maximum limit. A hasp for use with the lock, and kit of parts, is further disclosed.

### CROSS-REFERENCE TO RELATED APPLICATIONS

This application claims priority to United Kingdom Patent Application No. GB2314110.4 (filed 15-Sep.-2023), the entire disclosure of which is incorporated herein by reference.

### TECHNICAL FIELD

The invention relates to a lock and hasp suitable for locking an airline cart.

### BACKGROUND

Locking devices are used to lock the door of various airline carts. Airline carts are those used to distribute high value goods and consumables to airline passengers during a flight.

These carts are susceptible to being targeted by thieves who desire the supplies withheld in the airline carts. The carts are loaded with the supplies in a depot then transported to the airport to be transferred onto the planes. Theft can occur anywhere along the route the carts travel from the depot to the aircraft.

Typical locking devices, such as that disclosed in EP1672607B1, may be locked to the cart door using two methods, by using different hasps. A plastic U-shaped hasp may be passed through the locking points located on the door of the cart then inserted into the lock. The plastic hasp is frangible by hand and can be removed at will by staff on the aircraft. Alternatively, a metal U shaped hasp may be used instead of the frangible plastic hasp. Such metal hasps requires a cutting tool to remove thus releasing the cart door to gain access to the goods within. The appropriate hasp may be selected when loading the carts and the supplies being loaded.

Plastic hasps lend themselves to low value goods (such as complimentary inflight refreshments). Metal hasps are utilized to restrict access to higher value goods, such as duty free goods available for purchase in flight.

Despite the use of metal hasps for increased security, the locks are susceptible to other forms of attack and bypass, such as picking, shimming, and bumping, which enable nefarious actors to access the restricted supplies. These techniques may be non-destructive to the lock or hasp; therefore such attacks and unauthorized removal of supplies may go undetected.

### BRIEF SUMMARY

According to the disclosure there is provided a lock, suitable for locking an airline cart, the lock comprising: a body; at least two locking arms housed within the body; wherein the at least two locking arms are configured to resist removal of a hasp inserted into the lock; the at least two locking arms are tied to one another such that the at least two locking arms may reversibly move relative to one another, wherein an amount of movement of a first locking arm relative to a second locking arm has a maximum limit; and the lock further comprises biasing means, the biasing means arranged to urge the first locking arm and the second locking towards the maximum limit. By biasing the at least two locking arms towards a maximum limit, describing a maximum distance of separation or distention of the two arms relative to one another, engagement of the locking arms with a hasp inserted therein is ensured. Tying the movement of the two arms together ensures that the pair, when at the maximum limit, must move together, facilitating removal of a broken hasp from the lock, as removal of one leg frees the locking arms to swing out of engagement with the other hasp leg.

Suitably, a thickness of the at least two locking arms is less than a thickness of a hasp. One attach against such locks is to insert a shim in a gap between the hasp leg and the lock body (or into another aperture of the lock body), the shim catches on one of the locking arms and then a nefarious actor can push, via the shim, the locking arm out of engagement with the hasp leg, thereby releasing the lock and gaining access. Making the locking arms have a dimension smaller than the hasp leg means that if a shim is inserted, it cannot catch the locking arm, as the larger hasp ensures the shim overshoots its target.

Preferably, the maximum limit corresponds to a distance between two legs of a hasp. Ensuring the maximum limit corresponds to the distance between the two hasp legs ensures that the locking arms, when at the maximum limit, are engaged in a locking fit with the hasp.

Suitably, the movement is a rotation about a pivot point, such that the two locking arms may rotate relative to one another about the pivot point. The pivot point may be provided at any suitable location such as at an end of the arms, or an intermediate point along the length of one or both arms.

Preferably, the at least two locking arms are tied at the pivot point, the pivot point may therefore serve a dual purpose, allowing the arms to move relative to one another, but also dictating that movement and the degree to which movement is permitted.

Suitably, the maximum limit is set by providing at least one of the at least two locking arms with a shoulder arranged coincident with a path of travel of another of the at least two locking arms. The shoulder interferes with the path of travel of the opposing locking arm, thereby preventing movement of the locking arm past the shoulder.

Preferably, at least one of the at least two locking arms comprises a ramp allowing a broken leg of a hasp to completely pass the at least one of the at least two locking arms. The ramp therefore acts as a one way permissive gate, allowing a leg to be pushed through and past the relevant arm, but not withdrawn in the opposite direction.

Suitably, the body comprises an aperture arranged to allow a broken leg of a hasp to pass through the lock. A leg of a hasp can therefore be inserted into the lock and may pass straight through the body, passing the locking arms, and out of the body aperture.

Preferably, once the broken leg has completely passed the at least one of the at least two locking arms, the at least two locking arms, which arranged at the maximum limit, may freely move in unison within the body to release a further broken leg of hasp from the lock. In this way, the locking arms can swing or otherwise translate in a direction free of engagement with the other leg of the hasp, allowing the remainder of the hasp to be removed from the lock.

Suitably, the lock further comprises the lid arranged to cooperate with the body to form a lock housing, wherein the lid further comprises at least one aperture arranged to accommodate at least one leg of a hasp.

Preferably, the body comprises an attachment point, from which the body may be attached to a third party item, such as a cart used on an airline.

According to a further section of the disclosure, there is provided a hasp, suitable for use with the lock described herein, wherein the hasp comprises at least two legs, the at least two legs sized and spaced to locate into the body, the legs comprising one or more respective trapping wells to capture respective of the at least two locking arms, wherein the hasp further comprises at least one break point intermediate the at least two legs.

Suitably, the hasp is formed of metal or plastic, thereby allowing an end user to select the most appropriate hasp for their application, with a metal hasp being more difficult to remove than a plastic hasp, as a tool is required rather than removal by hand alone.

Preferably, the at least one break point is arranged on the hasp such that the hasp may be broken by hand by a user, therefore no additional cutting tools are required for the hasp to perform its function, and ensures easy removal in environments where such tools may be prohibited, such as during a flight. This may be achieved by arranging the at least one break point adjacent to the body or towards the midpoint between respective ends of the hasp.

The locks and hasps described herein may be provided as a kit of parts. A cart, such as an airline cart may be pre-provided with the lock as described above, and optionally with the hasp as described above.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 shows a cross section of a lock.

FIG. 2A and B show a first example of a hasp.

FIG. 3 shows a second example of a hasp.

FIG. 4 shows a hasp inserted into a lock (shown in cut away).

FIG. 5 shows a broken hasp inserted into a lock (shown in cut away).

### DETAILED DESCRIPTION

Certain terminology is used in the following description for convenience only and is not limiting. The words ‘right’, ‘left’, ‘lower’, ‘upper’, ‘front’, ‘rear’, ‘upward’, ‘down’ and ‘downward’ designate directions in the drawings to which reference is made and are with respect to the described component when assembled and mounted. The words ‘inner’, ‘inwardly’, ‘outer’ and ‘outwardly’ refer to directions toward and away from, respectively, a designated centerline or a geometric center of an element being described (e.g. central axis), the particular meaning being readily apparent from the context of the description.

Further, as used herein, the terms ‘connected’, ‘attached’, ‘coupled’ and ‘mounted’ are intended to include direct connections between two members without any other members interposed therebetween, as well as indirect connections between members in which one or more other members are interposed therebetween. The terminology includes the words specifically mentioned above, derivatives thereof, and words of similar import.

Further, unless otherwise specified, the use of ordinal adjectives, such as, “first”, “second” and “third” etc. merely indicate that different instances of like objects are being referred to and are not intended to imply that the objects so described must be in a given sequence, either temporally, spatially, in ranking or in any other manner.

Like reference numerals are used to depict like features throughout.

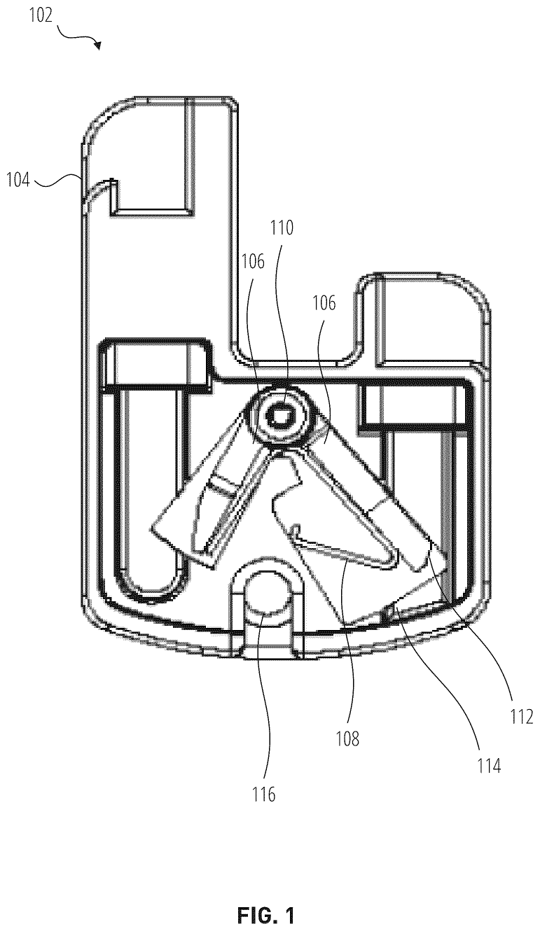

FIG. 1 shows a body 104 of a lock 102, in cut away. In use the body 104 is permanently attached to an airline cart and coded with indelible marked imagery (such as by laser engraving) to meet labelling requirements of Airline companies. The body 104 is intended to be retained with the airline cart. The body 104 also is attached via the attachment point 116, this eliminates bodies being moved between airlines. The body 104 is, for example, formed the following components, a lid (not shown), body case, at least two locking arms 106, and biasing means 108, such as, but not limited to, a spring clip.

The body 104 has an attachment point 116 to allow a cord or other methods of ways to attach the body to the airline carts. The attachment point 116 can be any suitable to perform its function. As shown in FIG. 1, the attachment point 116 is a through aperture, but this is not essential.

The body case is asymmetrical in respect of the hasp location apertures. An aperture is provided for each leg of a hasp. One of the apertures is arranged such that more of one of the legs of the hasp needs to be inserted, or in other words, the body case accepts a larger portion of at least one leg of the hasp, than another leg of the hasp. This “high edge” (shown on the left hand side of FIG. 1), is to restrict the carts' locking aperture movement. The carts' locking aperture is the rings provided on the door and jamb of the cart through which the hasp is inserted and thereby prevent opening of the cart when locked. Providing a “high edge” on the body 104 prevents the cart from being forcibly opened by minimizing maneuverability of the lock and denying a nefarious actor a lever point to force the lock from the cart.

The lid (not shown) is arranged to cover, and seal, the body case thereby protecting the lock from ingress of dust, dirt, providing mechanical protection from bumps and knocks, as well as inhibiting access to the lock mechanism from those desirous to bypass or break the lock. To ensure the lid cannot be separated from the body case when the lock is in use, the lid is provided with hasp retainers. These can be provided as, for example, apertures in the lid which capture the hasp legs as the hasp is inserted into the body case. This means the lid cannot be removed unless the hasp is also removed from the body. Once the lid has been permanently fixed (such as, but not limited to welding) onto the body and a hasp is inserted, the lid cannot be forcibly removed away from the body without destroying the hasp, thereby evidencing tampering.

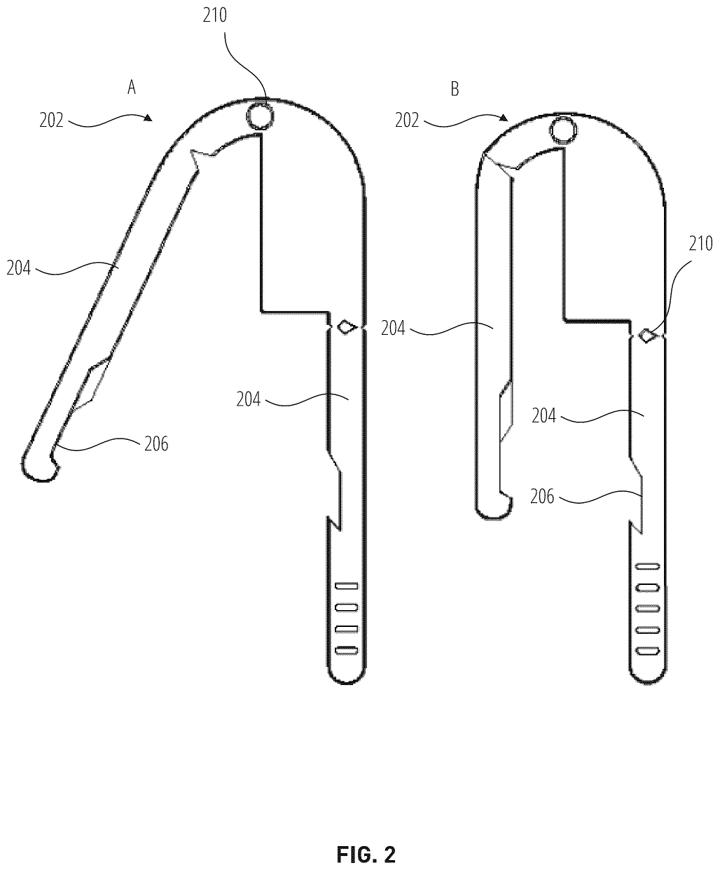

As discussed above a selection of hasps are available to the end user and they are above to select the most appropriate hasp for their requirements. FIG. 2A and B show a first example hasp 202 that is formed of a frangible material, such as a plastic. The plastic locking hasp 202 is flexible and is able to switch between a first extended form (FIG. 2A) and a collapsed form (FIG. 2B) due to the natural resilience of the material the hasp is formed from (materials other than plastic which exhibit a similar resilience may be substituted).

The hasp 202 has two break points, one break point 210 is to enable the hasp to be removed easily by the user and is located upon a leg of the hasp, such that squeezing the hasp.

The second break point 210 is to ensure the hasp breaks if the cart is being forcibly opened without removing the hasp deliberately. This second break point 210 is located at or around an apex of the hasp such that pulling the lock away from airline cart causes rupture of the hasp 202 leg. The apex of the hasp naturally sits aligned with the apertures of the airline cart, it is therefore clear that such a break point 210 does not need to located at the apex as such, but at a location on the hasp that aligns with the apertures of the airline cart when the lock is a rest, but in a locked position, upon the airline cart.

The hasp 202 comprises at least two legs 204, such that the hasp 202 is substantially “U” shaped overall. Each of the at least two legs 204 comprises one or more trapping well 206 arranged to align and bind with locking arms 106 of the lock to hold the hasp securely in place within the body. It will be apparent that the traps need not be wells, but any feature allowing a secure grip between the relevant parts of the lock 102 and hasp 202.

The hasp 202 is asymmetrical and has an area of increased thickness towards an apex, intermediate the ends of the at least two legs 204. Such an area of increased thickness prevents an airline cart being opened, once sealed, by way of rotating the metal hasp perpendicular to the locking aperture. The area of increased thickness resists such a manipulation of the lock.

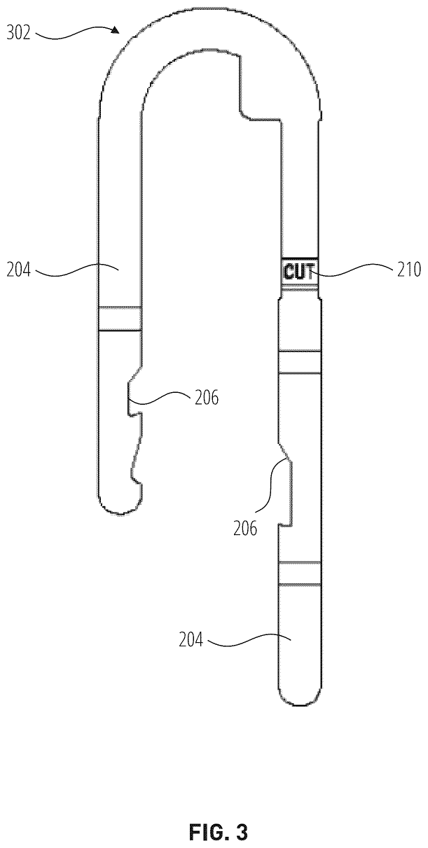

FIG. 3 shows a second example hasp 302, which is similar to the hasp 202 of FIG. 2, sharing like features which are provided like symbols. These features are not discussed again in order to avoid unnecessary repetition. The hasp 302 is formed of a material that requires a tool to rupture one or more at least two legs 204 at a break point 210. Hasp 302 is provided with a single break point 210 on one of the at least two legs 204 as the natural resilience of the material is sufficient to render a second break point 210 towards an apex of the hasp 302, similar to hasp 202, redundant.

Suitable materials are typically a metal, such as steel, or could be an equivalent material such as a reinforced polymer composite, provided the material was not frangible by hand.

The hasp 302 is also asymmetrical, similar to the hasp 202, and has an area of increased thickness towards an apex, intermediate the ends of the at least two legs 204. Such an area of increased thickness prevents an airline cart being opened, once sealed, by way of rotating the metal hasp perpendicular to the locking aperture. The area of increased thickness resists such a manipulation of the lock.

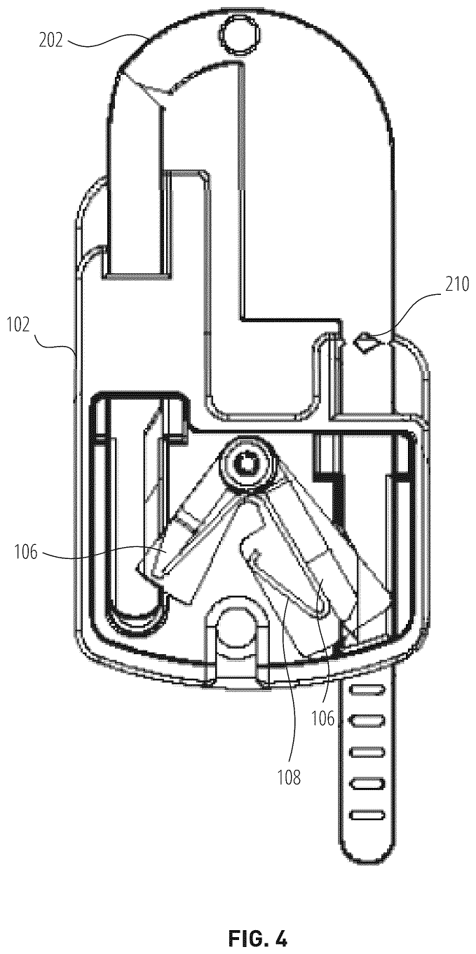

FIG. 4 shows the lock 102 in operation with a hasp 202 inserted. The locking arms 106 engage into the trapping well 206 on the at least two legs 204 of the hasp 202. The locking arms 106 move (such as by rotation) towards the center of the body 104 as the hasp 202 is inserted. A biasing means 108, such as but not limited to a spring clip, acts on both of the locking arms 106 simultaneously (although separate biasing means, one per each of the locking arms 106 could be provided), urging each of the locking arms 106 outwards, relative to a center of the body 104, such that the locking arms 106 engage with the trapping well 206 on each of the at least two legs 204 of the hasp 202.

The lock 102 therefore acts as a one way gate, allowing the at least two legs 204 to be inserted, and pass by, the locking arms 106 in a single direction, but not return.

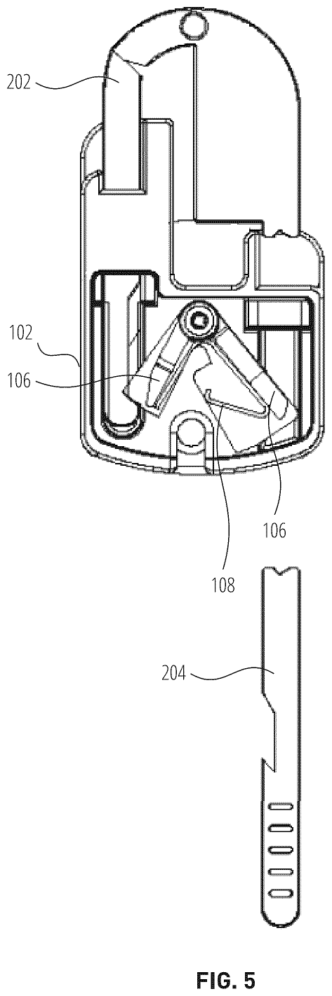

FIG. 5 shows the lock 102 further in operation, in a partially unlocked state. When a user intends for the lock to be rendered open, at least one of the at least two legs 204 of the hasp 202 are broken at a break point 210. Depending on which hasp is used, this may be performed by hand if using the hasp 202 of FIG. 2, or by using a cutting tool if using the hasp 302 of FIG. 3. The hasp 202 of figure two is discussed for ease below, but the comments apply equally to the hasp 302 of FIG. 3.

Once one of the at least two legs 204 of the hasp 202 has been removed the locking arms 106 move in unison, as the locking arms 106 are tied together. The broken leg may be withdrawn from the body 104 completely via an aperture 114, although the leg could be retained in the body 104, provided sufficient void was provided within the body 104 for the broken leg to be moved clear of the locking arms 106.

Here “tied” means coupled or otherwise in communication with one another, such that a maximum movement relative between the locking arms 106 may not be exceeded. Once the broken leg is moved clear of the locking arms 106, the locking arms 106 move to fill the void left by the displaced broken leg. Movement of the locking arms 106 in unison into the void has the effect of disengaging at least of the locking arms 106 from engagement with the at least other of the at least two legs 204, this then releases the remaining unbroken one of the at least two legs 204, and allows the now broken hasp to be removed from the body, thereby opening the lock and allowing and the cart to be opened.

Carts may be pre-provided with the lock as described above, and optionally with the hasp as described above. The idea is that the lock is permanently attached to cart so it cannot be separated from the cart no matter where the cart travels. The carts may be pre-sealed using a hasp, or simply be provided with a lock ready for a hasp to be attached and thereby lock a door of the cart.

Carts are typically those used on airlines, comprising a door, having a locking point (typically a pair of metal loops fixed to the cart body and to the cart door respectively). Such carts normally comprises one or more wheels attached to the cart base to allow easy relocation of the cart.

It will be appreciated by persons skilled in the art that the above detailed examples have been described by way of example only and not in any limitative sense, and that various alterations and modifications are possible without departing from the scope of the invention as defined by the appended claims. Various modifications to the detailed examples described above are possible.

Through the description and claims of this specification, the words “comprise” and “contain” and variations of them mean “including but not limited to”, and they are not intended to (and do not) exclude other moieties, additives, components, integers or steps. Throughout the description and claims of this specification, the singular encompasses the plural unless the context otherwise requires. In particular, where the indefinite article is used, the specification is to be understood as contemplating plurality as well as singularity, unless the context requires otherwise.

Features, integers, characteristics, compounds, chemical moieties or groups described in conjunction with a particular aspect, embodiment or example of the invention are to be understood to be applicable to any other aspect, embodiment or example described herein unless incompatible therewith. All of the features disclosed in this specification (including any accompanying claims, abstract and drawings), and/or all of the steps of any method or process so disclosed, may be combined in any combination, except combinations where at least some of such features and/or steps are mutually exclusive. The invention is not restricted to the details of any foregoing embodiments. The invention extends to any novel one, or any novel combination, of the features disclosed in this specification (including any accompanying claims, abstract or drawings), or to any novel one, or any novel combination, of the steps of any method or process so disclosed.

1. A lock, suitable for locking an airline cart, the lock comprising:
a body;
at least two locking arms housed within the body; wherein
the at least two locking arms are configured to resist removal of a hasp inserted into the lock;
the at least two locking arms are tied to one another such that the at least two locking arms may reversibly move relative to one another, wherein
an amount of movement of a first locking arm relative to a second locking arm has a maximum limit; and the lock further comprises
biasing means, the biasing means arranged to urge the first locking arm and the second locking towards the maximum limit.

2. The lock of claim 1, wherein a thickness of the at least two locking arms is less than a thickness of a hasp.

3. The lock of claim 1 or claim 2, wherein the maximum limit corresponds to a distance between two legs of a hasp.

4. The lock of any one of claims 1 to 3, wherein the movement is a rotation about a pivot point, and optionally wherein the at least two locking arms are tied at the pivot point.

5. The lock of claim 4, wherein the maximum limit is set by providing at least one of the at least two locking arms with a shoulder arranged coincident with a path of travel of another of the at least two locking arms.

6. The lock of any one of claims 1 to 5, wherein at least one of the at least two locking arms comprises a ramp allowing a broken leg of a hasp to completely pass the at least one of the at least two locking arms.

7. The lock of any one of claims 1 to 6, wherein the body comprises an aperture arranged to allow a broken leg of a hasp to pass through the lock.

8. The lock of claim 6 or 7, wherein, once the broken leg has completely passed the at least one of the at least two locking arms, the at least two locking arms, which arranged at the maximum limit, may freely move in unison within the body to release a further broken leg of hasp from the lock.

9. The lock of any one of claims 1 to 7, wherein the lock further comprises the lid arranged to cooperate with the body to form a lock housing, wherein the lid further optionally comprises at least one aperture arranged to accommodate at least one leg of a hasp.

10. The lock of any one of claim 1-7 or 9, wherein the body comprises an attachment point.

11. A hasp, suitable for use with the lock of any one of claims 1 to 10, wherein the hasp comprises at least two legs, the at least two legs sized and spaced to locate into the body, the legs comprising one or more respective trapping wells to capture respective of the at least two locking arms, wherein the hasp further comprises at least one break point intermediate the at least two legs.

12. The hasp of claim 11, wherein the hasp is formed of metal or plastic, and optionally wherein the at least one break point is arranged adjacent the body or towards the mid point between respective ends of the hasp.

13. A kit of parts comprising a lock according to any one of claims 1 to 10 and a hasp according to any one of claim 11 or 12.

14. A cart comprising a lock as claimed in any one of claims 1 to 10.

15. A cart as claimed in claim 14, further comprising a hasp as claimed in claim 11 or claim 12, and optionally wherein the cart is an airline cart.
